(19) United States
(12) Patent Application Publication
(10) Pub. No.: US 2014/0267599 A1
(43) Pub. Date: Sep. 18, 2014

(54) USER INTERACTION WITH A HOLOGRAPHIC POSTER VIA A SECONDARY MOBILE DEVICE

(71) Applicant: 360BRANDVISION, INC., Las Vegas, NV (US)

(72) Inventors: Sylvio Drouin, San Francisco, CA (US); Ron Martin, Stuart, FL (US)

(21) Appl. No.: 13/927,785

(22) Filed: Jun. 26, 2013

Related U.S. Application Data
(60) Provisional application No. 61/781,424, filed on Mar. 14, 2013.

(51) Int. Cl. G03H 1/00

(52) U.S. Cl. CPC G03H 1/00
USPC 348/41

(57) ABSTRACT

The invention provides a holographic display device that registers an individual through their mobile device to allow that individual user to control and interact with a holographic display presented by the device. The holographic display device is operable to receive from a mobile device information identifying a user of the mobile device. The display device can register a user of the mobile device as a present user of the holographic device, receive an input from the registered user, and present a holographic display that includes content governed by the input.

### CROSS-REFERENCE TO RELATED APPLICATION

This application claims priority to U.S. Provisional Patent Application Ser. No. 61/781,424, filed Mar. 14, 2013, the contents of which are incorporated by reference.

### FIELD OF THE INVENTION

The invention generally relates to holographic posters and to the registration of users.

### BACKGROUND

People need information to help them satisfy their many needs and desires. Information is often provided in the form of advertisements such as posters, commercials, billboards, or movie previews. Some firms have sought to use electronic equipment with advertisements. See, for example, U.S. Pat. No. 8,418,387 to Swatt; U.S. Pat. No. 8,330,613 to Gothard; U.S. Pat. No. 8,116,081 to Crick; U.S. Pub. 2003/0105670 to Karakawa; U.S. Pub. 2002/0095334 to Kao; and U.S. Pub. 1213/0050060 to Ranger.

Unfortunately, despite advances with electronic components, much advertising apparently fails to engage any viewers. In fact, the very proliferation of video advertising in every location such as at gas pumps and in airport terminals may be causing more and more people to simply tune out those video clips that play repeatedly everywhere.

### SUMMARY

The invention provides a holographic display device that registers an individual through their mobile device to allow that individual user to control and interact with a holographic display presented by the device. The invention includes the insight that the holographic display, being proximally computer generated, can be governed by input that can be situational or personal and that this input can be marshaled by registering users through detecting or interacting with their mobile devices. Thus a holographic display device of the invention can detect the approach or proximity of a user, receive information to identify the user, and associate the identifying information with an account of the user. The display content can then be personalized based on categories of the user's interests, user input (e.g., an interactive game played out within the display), environmental circumstances (e.g., a digital character while speaking can turn its attention towards a user), other attributes and combinations thereof. Since the holographic display device is registering the presence of a mobile device and allowing the user to govern the content, the contents of the display engage and maintain the user's attention, giving potent effect to the intended communication purpose. Additionally, since the user's option to register and interact carries a volitional element, the captured attention is intentional and voluntary and the user is pre-disposed to receive the intended message and internalize it. Thus a holographic display device that includes a method and mechanism for registering a user, associating their identity with an account, and presenting information that is governed by aspects of the user's contributions is a very effective tool for communicating with people. This effective communication delivers to people the information they need to satisfy their needs and desires.

In certain aspects, the invention provides a holographic display device that includes a memory coupled to a processor and operable to receive from a mobile device information identifying a user of the mobile device. The display device can register a user of the mobile device as a present user of the holographic device, receive an input from the registered user, and present a holographic display that includes content governed by the input. Preferably, the content comprises an interactive display. In some embodiments, the interactive display includes holographic images of characters and the display device can receive controlling input originating from the user's use of the mobile device and control the holographic images of the characters according to the controlling input.

The display device may include additional features such as a camera to perform, along with the processor, a facial recognition process to receive the information identifying the user. Thus the holographic display may include an image of a face and an animated interaction of the image of the face with the user. In certain embodiments, the display device is operable to determine the identity of the user and then to select a likely content preference of the user based on the facial recognition operation.

The display device is operable to register the user. For example, the display device may receive a registration request transmitted by a mobile app on the mobile device. The display device may be operable to use the processor to detect a presence of the mobile device and associate the mobile device with an account for the user. In some embodiments, the user is registered by retrieving information from a social media web site. The display device may be used to register a plurality of users of mobile devices and queue users to receive a plurality of different holographic displays. Optionally, the device is operable to select the content based on an identity of the user. In some embodiments, the display device is further operable to associate the user with a unique account, retrieve a content category identifier from the account, and receive the content from a server system based on the content category identifier.

The display device itself may prompt the user to install a mobile app onto the mobile device. Prompting the user may include a visual sign or code.

Additionally, systems and methods of the invention provide augmented reality functionality through servers, the display device, the mobile device, or combinations thereof. For example, the processor of the display device or one in the mobile device may be operable to generate a live view of a real-world environment that includes artificial computer-generated elements.

The display device may present the holographic display at least a few feet above ground and including images at least about a foot wide and a foot tall.

To interact with the mobile device as it moves (e.g., from Wi-Fi range to cell tower range), the processor may execute a handoff procedure between a first communication modality with the mobile device and a second communication modality. Preferably, communication with the mobile device is uninterrupted throughout a duration of the handoff procedure. In some embodiments, the first communication modality comprises Wi-Fi and the second communication modality comprises cellular telephony data systems.

In some embodiments, the display device can determine the proximity of the mobile device to the display device. The display device may also detect an approach of the mobile device and register the user in response to the detected approach. In some embodiments, the display device registers the user by communicating with a server system. The display device may use a server system to synchronize the holographic display to actions on the mobile device.

Systems and methods of the invention include functional implementations of groups of the display devices or multitudes of mobile devices. For example, the registering display device may relay a user registration to an entirety of the group of holographic poster devices. In some embodiments, the display device is operable to lock in the mobile device, recognize the presence of a plurality of additional devices, and maintain the locked-in mobile device as the sole locked-in device. The display device may register and queue multiple additional mobile devices. The display device may accept multiple simultaneous users queued as a group. The display device may go directly to queuing if the user is already registered.

The invention provides systems and methods for a variety of other functionality. The display device may prompt the user through the mobile device to ask if they want to interact with the display device. The display device may insert the user into a queue of available interaction slots. The display device may display names from an interaction queue. The display device may re-skin a mobile app on the mobile device with a new skin, the skin comprising at least one element (e.g., a trademark) in common with the holographic display. The display device may allow two locked-in users to alternate control of the display device.

In some embodiments, the display device is used to display content related to a game

The display device may use the processor to reconfigure content of the holographic display based in additional input from the mobile device. The reconfiguring may include geometry transformations, motion control, selection, view control, other content manipulation, and combinations thereof. The contents of the holographic display can be moved in accordance with movement of the user's finger on a touch screen of the mobile device. In some embodiments, the display device cycles through a series of holograms in response to a swiping input. The display device may use a 3D camera to capture a 3D image, receiving pan-and-scan input from the user, move the 3D camera, and adjust the 3D image.

The display device may use sensors on the mobile device to aid in sifting through a crowd and source an action of the user to that user despite the presence of the crowd. A sensing mechanism on the display device can be used to receive additional input containing information about the action sourced to the user.

In certain embodiments, the display device will terminate the user's control of the display device.

Aspects of the invention provide a mobile device for controlling a holographic display. Generally, the mobile device will have a mobile form-factor body housing a processor coupled to a memory and housed by the body and at least one input-output mechanism for receiving an input from a user plus at least one communication mechanism for sharing information with a holographic poster. Instructions stored in the memory are executable by the processor to cause the device to transmit the input to the holographic poster (e.g., a holographic display device) and influence a holographic display presented by the poster. The mobile device can determine positions of nearby holographic posters; sense a proximal holographic display device; determine a distance to a holographic display device; or make other such determinations using, for example, GPS, Wi-Fi trilateration, and SSID broadcasting.

The mobile device can be used as a controller to interact with content being displayed on a holographic display device.

In some embodiments, the mobile device includes at least one positional sensor such as a gyroscope, accelerometers, or GPS structure. The mobile device may include a touch screen operable to receive and digitize gesture information. In certain embodiments, the mobile device is operable to receive a user selection of a specific holographic poster and display a version of a portion of current content being displayed on the specific holographic poster. The mobile device may be caused to display a map with instructions on how to reach the specific holographic poster. The mobile device may display an augmented reality display with annotation information appearing within a live video as the user points the phone in different directions.

The mobile device may query a server database that contains the location data for all holographic display devices within a defined group. In certain embodiments, the mobile device is operable to send information identifying a present location of the mobile device to a server and receive a set of coordinates for holographic display devices within a pre-determined radius from the present location. In some embodiments, a camera and a screen can be used to show a display with contents that mimic a view behind the screen of the device and to include additional information in the contents.

In certain aspects, the invention provides a holographic poster device that has a body supporting a display area and a computing device. The computing device includes a processor, a memory, and a display processing means (e.g., a video card connected via an expansion port on a motherboard or an integrated graphics chipset on a motherboard) and is operable to make a holographic image appear in the display area. The body may be in the form of a pedestal configured to sit on a floor with the display area at the top of the pedestal, preferably at least a few feet above the floor. The display area uses an electronic display source and a visible display area which can include, for example, a panel of at least partially reflective material disposed above the electronic display source at an angle with respect to the horizontal. In some embodiments, the material is a beam splitter at an angle between 35° and 65°. In certain embodiments, the display area uses an electronic panel disposed substantially horizontally when the pedestal is sitting on the floor, and a panel comprising an at least partially reflective material disposed at an angle above the electronic panel (e.g., between about 40° and about 50°).

The computing device operates to display images in the display area and may further include a network connection device such as a Wi-Fi card, Ethernet jack, or cellular modem. The device can use a wireless connection mechanism to exchange information with a handheld apparatus nearby such as the smartphone of a passerby.

In certain embodiments, the computing device is operable to stream images from a distal source while receiving a signal through the network connection device and display images from the memory while not receiving a signal through the network connection device.

A holographic poster may further include such features as stereo speakers, a touch-sensitive input device, a camera, others, or a combination thereof. The computer device can perform 3D processing such as z buffering on data captured by the camera. In some embodiments, the poster includes a graphics card comprising a RAM chip and a graphics processing unit.

In certain aspects, the invention provides a holographic poster (i.e., a display device) that includes a pedestal to sit on a floor, a beam splitter disposed at an angle to the horizontal at the top of the pedestal, and an image source configured to cast an image onto the beam splitter. A computer device coupled to the image source provides display content. The image source may be a flat-panel monitor or other image generation means. The image source may be concealed from the view of a person standing near the poster. In certain embodiments, the beam splitter is at least about four feet above the floor. In general, the computer device includes a processor coupled to a memory and may include a graphics card that itself has a graphics processor. The computer device may be operable to receive the display content from a server computer and store the display content in memory therein. In some embodiments, the computer device is operable to exchange information with a mobile device nearby and control the display content according to user input received via the mobile device.

The holographic poster may further include a sensor to detect motion within a few feet of the device. The computer device can cause the display content to form a holographic video mimicking the detected motion, thus providing an interactive or user-controlled display.

### BRIEF DESCRIPTION OF THE DRAWINGS

FIG. 1 shows a holographic poster according to certain embodiments.

FIG. 2 shows a design of hardware components of a system of the invention.

FIG. 3 diagrams software components of certain embodiments.

FIG. 4 depicts a holographic poster connected to server via a network.

FIG. 5 gives a detailed view of the display area of a holographic poster.

FIG. 6 diagrams controlling a holographic poster with a separate mobile device.

FIG. 7 illustrates proximity determination via GPS radius.

FIG. 8 shows trilateration using stationary routers.

FIG. 9 shows using Wi-Fi and proximity detecting using SSID broadcasting.

FIG. 10 illustrates augmented reality embodiments.

FIG. 11 depicts street-level navigation via an augmented reality module.

FIG. 12 gives an augmented reality preview of holographic content.

FIG. 13 shows layers between a mobile device and a holographic poster.

FIG. 14 illustrates Bluetooth connection between a mobile and a holographic poster.

FIG. 15 shows registration and queuing.

FIGS. 16A and 16B illustrate use of a mobile device to control a holographic poster

FIG. 17 shows an interactive game of holographic chess.

FIG. 18 gives a diagram of termination according to some embodiments.

### DETAILED DESCRIPTION

The invention provides systems and methods by which a user may find and interact with one or more public or private space holographic poster 101 as shown in FIG. 1. Different mechanisms may be involved in finding and interacting with a holographic poster 101 without physically touching the device and with or without the device supporting any form of sensor input. This may be achieved via the usage of a secondary device which can include a mobile phone such as a smartphone or a tablet or any other form of mobile device capable of communicating with a server via some form of networking infrastructure (cellular, satellite, cable, wireless). Interaction may include sensors (e.g., for motion detection), data transfer, facial recognition, and other methodologies.

The invention provides systems and methods for numerous aspects of an interaction session including identification, registration, queuing, interaction and termination as well as technical solutions related to how a user will find and interact with a holographic poster 101.

Broadly speaking, and without limiting implementations and embodiments herein, communication methodologies provided for by systems and methods of the invention may include several party entities and for convenience of illustration, some of those party entities may be referred to herein as an administrator, a communicator, and a user. An administrator may include an entity that operates or controls the operation of a server, provides one or more holographic kiosks, or a combination thereof. A communicator may be a customer of the administrator who seeks to have content or advertisement delivered to an end-user via a holographic kiosk or like installation. A user may be person who gives attention to the content being displayed by a holographic kiosk. In certain embodiments, a communicator uses one or more holographic kiosks that are administered by the administrator to advertise products to a user. In some embodiments, communication includes establishing a relationship between a mobile device of a user and a holographic kiosk.

Identification through a holographic kiosk of a user's mobile device (and the user) may be accomplished any suitable mechanism such as custom Wi-Fi relays, GPS radius intersection, augmented reality finder maps (point toward a point in space and observe a map or directions on how to find the nearest holographic poster 101 as well as information on the brand owning the holographic poster 101), facial recognition, others, or a combination thereof. Such an identification process can then lead to registration via server systems that support the holographic kiosk(s) (and associated social media authoring mechanisms such as open standards for authorization like OAuth or OpenID, Facebook connect, twitter, etc.) A registered mobile device is used to control and interact with the content broadcasted on the holographic poster 101 the servers.

In certain embodiments, registration includes a facial recognition operation. Holographic poster 101 may include a camera and a software module for facial recognition. Alternatively or additionally, a camera on a mobile device may be used. Facial recognition allows poster 101 to associate the presence of a person with accessible digital data related to that person. For example, a user who has previously registered or who has generated an allowance for access to information in a social media account or profile by be photographed by a camera. A facial recognition module can associate that person with their account and retrieve information from the account or based on what is in the account. Additionally, facial recognition modules may be used to create digital inferences about a disposition of the user (e.g., a vector of variables output by a facial recognition algorithm can be used to select a category representing an inference about the user's present disposition where categories could include, for example, excited, pleased, bored, inattentive, distracted, active, or the vector could resolve categories relating to other features such as demographics). Facial recognition adds security controls where, for example, young people are not shown previews for R-rated movies. Facial recognition is known in the art and is described, for example, in U.S. Pat. No. 8,411,909; U.S. Pat. No. 8,406,484; U.S. Pat. No. 7,203,346; U.S. Pub. 2013/0121540; U.S. Pub. 2012/0288165; U.S. Pub. 2012/0278176; and U.S. Pub. 2012/0235790, the contents of each of which are incorporated by reference.

In some embodiment, the holographic kiosk comprises a poster or device that is on display in public and open to one or more users that may interact with the device at the same time. A lock-in and queuing system is provided in order to manage multiple users. In this system, users may approach a holographic poster 101 and enter into communication with it in order to become registered on the device and to get in a queue to wait for a turn to control the holographic poster 101. The user is then locked into the device to control it. In a preferred embodiment, there is only one controller of the holographic poster 101 at a time during certain content delivery. However, is some circumstances there could be two controllers of the holographic poster 101 with certain controls. For example there could be two controllers interacting with the holographic poster 101 if they controlled different parts of the hologram. Preferably, the holographic poster 101 and mobile device are two different devices with two different display systems that are synchronized at the server level.

FIG. 1 shows a holographic poster 101 according to certain embodiments. Holographic poster 101 generally includes display panel 105 extending above display source screen 109 and contains a computing system 121 therein. Holographic poster 101 may also include NFC device 125, speakers 129, support stand 133, hardware connections 137, stabilizing base 141, Wi-Fi device 145, sensor 149 (e.g., a motion sensor), Bluetooth device 153, camera 157 (e.g., a z-buffer camera), and one or any number of speakers 161.

In some embodiments, camera 157 is a stereo camera system. A stereo camera can detect and capture user gesture as a user interface in both 2d and 3d field. The purpose is to create an interactive user interface, thus making it more interesting to the viewer. Applications include providing information, games, point-of-purchase/point-of-sale functions, or a combination thereof. In a preferred embodiment a special z-buffer camera would be used as a depth-sensing camera to gather additional information that can be used by the holographic poster 101. (A z-buffer camera is capable of capturing 3d information.) The additional input from this camera could be used in conjunction with the motion sensor data to more accurately track a user's movements. It can also be used for standard 2D photo and video capture for live integration with currently playing holograms. Data captured with this special camera is sent to the modules running on the processor which also manages the incoming data from the sensors.

One exemplary depth sensing camera system for use with poster 101 is the real-time depth sensing camera system sold under the trademark ZCAM by JVC (Wayne, N.J.). A depth sensing camera system can operate by time-of-flight principles and include a near-infrared (NIR) pulse illumination component, an image sensor with a fast gating mechanism, and a software component. Based on the known speed of light, a depth sensing camera system coordinates the timing of NIR pulse wave emissions from the illuminator with the gating of the image sensor, so that the signal reflected from within a desired depth range is captured exclusively. The amount of pulse signal collected for each pixel corresponds to where within the depth range the pulse was reflected from, and can thus be used to calculate the distance to a corresponding point on the captured subject. Three dimensional imaging is discussed in U.S. Pub. 2012/0317511 to Bell; U.S. Pub. 2012/0268572 to Cheng; U.S. Pub. 2012/0287247 to Stenger; U.S. Pub. 2012/0249740 to Lee; and U.S. Pub. 2012/0242795 to Kane, the contents of each of which are incorporated by reference.

In some embodiments, device 101 includes a gesture detection technology such as that described in U.S. Pat. No. 8,269,175 to Alameh; U.S. Pub. 2013/0009896 to Zaliva; or U.S. Pub. 2012/0313882 to Aubauer, the contents of each of which are incorporated by reference. Gesture detection can be provided by hardware and a software application.

In some embodiments, speakers 161 may include a 3D speaker system to create surround audio to create the illusion of depth and movement in order to enhance the illusion of depth and presence. The purpose could be to assist the user in orientation when being directed in a certain way, audio can follow.

In some embodiments, speakers 161 may include a directional speaker system. Directional audio has the ability to direct messages to a very specifically located audience, down to one person only. This means that messages can be tailored very narrowly to target a higher value audience. Applications could be gaming, retail, banking, POS, POP. In some embodiments, device 101 includes a microphone. A microphone can allow for voice a voice-command controlled user interface. Holographic poster 101 may additionally include, for hardware connections 137, a CAT5 network connection device. This device could control network based devices as well as handling remote devices, servers and folders. In general, a holographic poster 101 according to the invention will include a computer system 121 to provide functionality.

FIG. 2 shows a design of hardware components of a computer system 121 provided with holographic poster 101 according to certain embodiments. A computer system 121 will generally include a processor 205 coupled to a memory 209 via a bus. FIG. 2 depicts a number of optional components as well. The hardware architecture for holographic poster 101 preferably includes a motherboard configuration that can include the following: a processor 205, a memory 209, a bus, a graphic card 213, a sound card, an Ethernet card or connection, i/o interfaces and tangible, non-transitory storage medium memory 219. Graphics card 213, called a video card or graphics adaptor in embodiments, is a structure that can provide display processing means.

Storage 219 could include a solid-state drive (SSD), hard disk drive (HHD), optical drive, flash memory, or a combination thereof. In a preferred embodiment, storage 219 includes an SSD, which is more resistant to physical shocks that might occur to the device. Storage 219 may store the instructions and code for the operating system (OS) and it may store any software that would run on the OS. The OS could be Linux, Windows, Mac OS, or some other embedded operating system. A preferred embodiment includes a custom version of Linux (using the latest build of Ubuntu) optionally stripped of all windowing systems and accepting remote secure shell (ssh) login and input.

The video card, or graphics card 213, renders holographic display information and relays the information to a display area capable of displaying a hologram (see, e.g., FIG. 11). Graphics card 213 can be a dedicated video card connected via an expansion port on the motherboard; an integrated graphics chipset on a motherboard; can be embodied within CPU 205; can be provided by one or more GPU located in poster 101 or in a remote computer such as a server; can have other structures and forms known in the art; or a combination thereof. In some embodiments, the poster includes a graphics card comprising a RAM chip and a graphics processing unit.

Graphics card 213, also occasionally called visual processing unit (VPU) or graphics processing unit (GPU), can provide a specialized electronic circuit to manipulate and alter memory to accelerate the building of images (e.g., within a frame buffer). Graphics card 213 is efficient at manipulating image data, and can include resources for 2D acceleration, 3D functionality, graphics-related application programming interfaces (APIs) such as OpenGL or DirectX, or general purpose GPU (GPGPU) development environments such as OpenCL or CUDA by NVIDIA. Graphics card 213 can include programmable shading (e.g., each pixel can be processed by a short program that can include additional image textures as inputs; each geometric vertex can be processed by a short program; etc.). Such functionality can be offered by OpenGL API, DirectX, and the GeForce chips by NVIDIA. Graphics card 213 may further include support for generic stream processing.

Computer system 121 may include one or more of graphics card 213. Any suitable GPU can be used, including, for example, those made by Intel, NVIDIA, AMD/ATI, S3 Graphics (owned by VIA Technologies), and Matrox. Card 213 can include a programmable shader or other resources to manipulate vertices and textures, perform oversampling and interpolation techniques to reduce aliasing, and very high-precision color spaces. In certain embodiments, graphics card 213 is a GTX680 (GK104 core), GT640M (GK107 core), GTX 660 Ti (GK104 core), GTX 660 (GK106 core), GTX 650 (GK107 core), or GTX690 by NVIDIA or a Radeon by AMD. In some embodiments, graphics card 213 includes an integrated ARM CPU of its own. Graphics card 213 may operate via OpeNVIDIA, OpenCL, or CUDA, an SDK and API that allows using the C programming language to code algorithms. graphics card 213 can process many independent vertices and fragments in parallel. In this sense, graphics card 213 is a stream processor and can operate in parallel by running one kernel on many records in a stream at once. In certain embodiments, system 121 a plurality of parallelized cards 213 (e.g., each itself configured to perform parallel operations). Parallelized GPU computing can be implemented using any suitable platform such as, for example, products from NVIDIA, or OpenCL. OpenCL is an open standard defined by the Khronos Group. OpenCL solutions are supported by Intel, AMD, NVIDIA, and ARM.

A stream includes a set of records that require similar computation. Streams provide data parallelism. Kernels are the functions that are applied to each element in the stream. In the GPUs, vertices and fragments are the elements in streams and vertex and fragment shaders are the kernels to be run on them.

As shown in FIG. 2, computer system 121 preferably includes an audio card. An audio card manages input sounds from the microphone and output sounds to the speakers. In a preferred embodiment the speakers would be a set of directional 3D speakers. An input/output or i/o controller would be used to communicate with and control a sensor device and a touch screen device for receiving user input. The bus on the mother board would also have a connection to a special Z-buffer camera (capable of 3D recording) to receive image data from the camera and transmit data to it. The bus is also connected to a Bluetooth device that transmits and receives a Bluetooth signal that can be used to communicate with a mobile device held by a user interacting with the holographic poster 101. The bus is also connected to an integrated Wi-Fi router broadcasting the SSID of the holographic poster 101 and creating another wireless communication channel with users. In some embodiments, the motherboard bus is also connected to near field communication (NFC) device. The NFC device also used for identification and registration of an approaching user. NFC standards cover communications protocols and data exchange formats, and are based on existing radio-frequency identification (RFID) standards including ISO/IEC 14443. In some embodiments, poster 101 includes components of the contactless system sold under the trademark FELICA by Sony Corporation (Tokyo, Japan). The standards include ISO/IEC 18092 and those defined by the NFC Forum.

In addition to storage device 219 storing an operating system, device 219 may also store custom software. The custom software, when executed, can perform one or more of the following: fetching playlists, content and branding information from a server and initiating, preparing or otherwise setting up the hardware to playback the downloaded content; offering interaction choices and selections to a user interacting with holographic poster 101; managing user queues for the holographic poster 101; controlling the i/o interfaces and managing the data going between the mother board and the i/o devices; performing and managing data capture; managing (via the video card) the 3D rendering for the hologram and controlling the hologram display; managing server updates; monitoring the health and repair of the holographic poster 101 software and hardware; remote login support; others; or a combination thereof. In a preferred embodiment the OS is stripped of all modules or elements except for those required for the said software. The said required modules that remain in the OS are part of the support libraries (for example, Unity3D engine) and basic monitoring and hardware health assessment procedures.

In some embodiments, device 101 includes a computer for handling content scheduling. This computer would handle precise play-out of appropriate content at a pre-determined time and date set by an administrator (e.g., personnel or remote computer operating poster 101). Appropriate content scheduling may be important to certain implementations and embodiments as advertising revenue can be maximized by not displaying advertising during times when a target audience is not likely to be viewing. For example, a sports arena could select certain ads to display depending on which team won a game just as that team won that game so that enthused fans would see the ad moments after the win as those fans filed from the arena.

In some embodiments, device 101 includes a computer system 121 with components for handling automatic remote download. Computer system 121 handles the download of off-site content at a pre-determined time, for instance at midnight every day. The system allows the admin to set a specific folder in a specific server and the system will automatically “look” for new files in the folder. If files are present, it will start download and play out as scheduling determines.

Holographic poster 101 may include digital multiplex (DMX) software per the standard for digital communication networks. The computer system 121 would handle the DMX timeline controlling lighting and other DMX controlled machines.

The computer system 121 can be included to handle touch interface software. The computer would handle input from a simple touch screen and translating input to play out of appropriate content.

The computer system 121 can handle synched multiple stream content, i.e., handle software with timeline to play out separate streams of content in synch. This would be used in systems with more than one LCD screen. For instance systems with one horizontally positioned LCD for refracted effects and one LCD screen for back drop images assembled in one array.

Holographic poster 101 may include facial recognition software. The computer would handle user-based input like facial expressions. For instance, if the system recognizes a smile, the system while activate an appropriate response or play out appropriate content.

Holographic poster 101 may include software that allows a device (smartphone, tablet etc.) to operate as a remote control. The computer would handle use input from outboard devices like smartphones and tablets. These would have a simple user interface like simple buttons that would control play out of appropriate content. In certain embodiments, the invention provides a user mobile app 427 that can be installed on the outboard device to provide a custom interface for controlling holographic poster 101.

Computer system 121 provides for control, scheduling, and storage of content and can also control audio, gesture processing, camera information, i/o devices. For example, computer system 121 can: provide control of audio like automatic level control in relation to ambient noise or stereo positioning relation to both content and user; handle simple gesture use input and control or play out appropriate content; handle user generated 3d and 2d gesture input and translate to appropriate response or play out of content; handle all input or output devices controlled by RS232 protocol; or a combination thereof. Computer system 121 can be provided as a single unit (e.g., as an off-the-shelf PC such as a desktop or laptop by Dell (Round Rock, Tex.)) or as a system of computer components and devices. Computer system 121 will generally operate by executing instructions provided by software.

FIG. 3 diagrams software components of certain embodiments. While a holographic poster 101 can interact with a user independently from a server, the software of holographic poster 101 may continually listen for commands from a remote server if an internet connection is available. These said commands can cause software to update, reconfigure, re-schedule or execute any other command sent from the server where client accounts are managed.

FIG. 4 depicts a system 401 with poster 101 connected to server 409 via network 421. An administrator can control poster 101 directly or via server 409 through the use of admin terminal 415. Poster 101 can be connected to a mobile device 425 that includes a user mobile app 427 and input/output mechanisms 437.

Various embodiments (discussed in greater detail herein) are possible. For example, communications may be implemented as a hardware-based implementation that does not depend in real-time on a server sending information for rendering the display. Rather than relying on a real-time server source, the hardware-based implementation downloads all the information that it requires in advance and can then operate independently of the server (except for updates and maintenance). Downloaded information may include content in the form of scripting modules, geometry, textures, animations, audio, video, images and everything else necessary to render the communicator's message or experience for the user including instructions for the poster 101 on how to interact with the user. A primary script module would be responsible for initializing the holographic poster 101 and using the downloaded content to display the initial hologram or series of holograms. The same script module, or a different one, would use a secondary touch screen for displaying menu options and receiving and processing text entry from the touch screen as well as receiving and processing touch gesture interactions. Once the initial holograms are displayed, the holographic poster 101 would accept input from a user via the sensors, touch screen or wireless communication (Wi-Fi, Bluetooth or NFC).

The described device and systems including one or more of the device employ the benefit of the holographic display effect of poster 101. The inclusion of a holographic display area in holographic poster 101 provides attractive communication and visual benefits.

The display for the holographic poster 101 uses a visual effect that mimics holography and creates the illusion of a 3D image. In some embodiments, the display area is one sided and open, which allows for the image to be set free floating in front of the display components. This design allows for the unit to be used for commercial purposes in public places; such as for example in a cinema lobby. The display area is illustrated in FIG. 5.

FIG. 5 gives a detailed view of the display area of poster 101 showing display panel 105 extending from attachment joint 1109. Connector 1119 can connect (e.g., via HDMI) to a source such as a graphics card or a player. Display source screen 109 is disposed under panel 105.

The glass attachment element 1109 holds the face of the glass at a 45 degree angle from the horizontal with the lowest point of the glass held between 2 and 4 inches above the display screen. In some embodiments, panel 105 includes a standard 40/60 Beam splitter glass with 40% reflective properties on the front and 0.05% reflection on the back side of the glass. The 2 to 4 inch separation from the bottom of panel 105 to the face of display source screen 109 creates the illusion of distance between the glass and the image content. Materials for use in panel 105 including beam splitter screens are discussed in U.S. Pat. No. 5,771,124; U.S. Pat. No. 5,572,229; U.S. Pub. 1212/0300275; U.S. Pub. 2009/0256970; and U.S. Pub. 2002/0075461, the contents of each of which are hereby incorporated by reference in their entirety for all purposes.

Display source screen 109 is preferably positioned below and pointing upwards towards panel 105. In a preferred embodiment display source screen 109 is a high definition display and with a bright output and high contrast. For example, a good display source screen 109 would be a flat LCD with a 16:9 aspect ratio, high resolution (1080 horizontal pixels), high brightness (1500 nits) and high contrast ratio (3000:1). The dimensions of the display area will depend on the dimensions of the display source screen 109. In a preferred embodiment the display source screen 109 would be a 47 inch LCD display and the dimensions of the display area above the display screen would be approximately 24″×42″×26″.

One exemplary screen placed horizontally to create refracted image on the panel 105 is a 46″ 3000 nit fanless high brightness LCD with narrow bezel sold under the model name ds46104 by DynaScan Technology, Inc. (Irvine, Calif.). In some embodiments, device 101 includes a stereoscopic LCD screen as display source screen 109 to perform the same purpose as LCD screen but stereoscopic. Would create actual stereoscopic image on MBG.

Device 101 could optionally include a privacy filter. A privacy filter would reduce the viewing angle to the LCD screen thus enabling the current screen height (5′8″) could be lowered without revealing the LCD screen image to the viewer.

Panel 105 may include a beam splitter such as a beam splitter glass sold under the trademark MIRONA by Schott North America, Inc. (Elmsford, N.Y.). Panel 105 is the termination point of the image emanating from the LCD screen. The beam splitter glass is coated on the front with a high reflective surface and a none reflective surface on the back. The purpose of the front coating is to increase refraction and the purpose of the rear coating is to reduce refraction in an effort to avoid “ghosting”. An effect that comes from seeing a reflection of the LCD image on both sides of the glass. Since the glass is at an angle of 45 degrees, the ghosting would not be aligned and less bright, it would create the unfortunate sense of defocus.

In some embodiments, holographic poster 101 makes use of LED-imbedded beam splitter glass. It is now possible to seamlessly imbed LED lights in low iron glass before the coating process. This would produce LED light, seemingly free floating on the glass itself. The refraction of the LCD screen would appear behind the beam splitter because the distance to the LCD image will repeat itself in the reflection. This means that the LCD's imbedded in the beam splitter would appear in front of the reflected image. Obviously the imbedded LCD's would be very simple and create a sense of depth.

In some embodiments, holographic poster 101 uses a translucent LCD panel 105 with optically bonded beam splitter glass. Beam splitter glass can be bonded to a translucent LCD. This allows an actual image to be created directly on the beam splitter that would run with the refraction from the LCD or stereoscopic LCD. In some embodiments, a translucent LCD panel is layered on top of regular or stereoscopic LCD screen. A different approached that places the translucent LCD on top of the horizontally positioned LCD screen at a certain distance. This creates further physical depth in the refraction on panel 105.

In some embodiments, holographic poster 101 includes one or more additional backdrop LCD panel. To create a backdrop to the refracted effect, an LCD is placed at a certain distance behind the viewing direction of the beam splitter. Content would be either be streamed in synch with the refracted image or “freewheel” none intrusive background content to create visible depth. This would be the same size LCD panel as the Dynascan 46″ unit but may be less bright.

In some embodiments, holographic poster 101 include one or more additional stereoscopic backdrop LCD panel, similar to above, but using a stereoscopic LCD screen. This was tested this using a low res stereoscopic screen and it adds significant depth to the effect in the beam splitter.

In some embodiments, holographic poster 101 includes one or more of a backdrop lighting bar (DMX controllable). Such a simple color lighting bar enhances depth of field behind the effect. For instance a dark wall would decrease the depth effect, but if lit, the depth effect can be enhanced.

The holographic poster 101 display screen is connected to and receives the display information from a graphic card or graphic device. In a preferred embodiment the connection is made with a high definition video cable such as an HDMI cable. The connection between the display screen and the graphic card 213 can be a network connection (TCP/IP accessible via remote ssh or protocol). The graphic card renders the hologram display information according to the commands sent by the rendering engine which itself receives commands from the hologram scripting modules.

In some embodiments, holographic poster 101 includes directional speakers and a 3D audio system. The holographic poster 101 includes a speaker system that is connected to the rendering engine driven by the core software modules. The speaker system can use conventional speakers or it can incorporate more elaborate directional speakers or 3D audio system to provide surround sound for the user.

Microphone and sound capture systems can be included. In some embodiments, the holographic poster 101 includes an audio/sound capture device connected to the main motherboard and driven by the software modules.

In some embodiments, device 101 includes a network and scheduling enabled flash card or video player. An HD video player such as the media player unit sold under the name HD220 by BrightSign, LLC (Los Gatos, Calif.) or the video media player sold under the trademark EYEZUP by Grandtec USA (Dallas, Tex.) can be included. A video player and software components can allow user-based interface with content. In some embodiments, holographic poster 101 includes a device such as an RS232 controllable player. A video player can include a RS232 machine control protocol to allow machine control of the unit from outboard RS232 input like simple buttons, step activated mats and simple beam breakers. Content generation can include methods described in U.S. Pub. 1212/0263433; and U.S. Pub. 2003/0105670. Other technologies adaptable for use with the invention are discussed in U.S. Pat. No. 6,512,607; U.S. Pub. 1211/0216160; and U.S. Pub. 2009/0021813.

FIG. 6 gives a walk-through of the process described herein for controlling a holographic poster 101 with a separate mobile device.

Step 601 as shown in FIG. 6 relates to finding and approaching holographic poster 101 To interact with a holographic poster 101 a user may use an installed mobile app. The user may be prompted to install the app via a visual sign on the holographic poster 101 itself or via a QR Code that can be parsed, directing user device 425 to a mobile app store linked to a page for downloading the mobile app 427 (where the app 427 can then be downloaded and installed).

In one embodiment the mobile app 427 is a universal app that works with all holographic poster 101 independently of the brand or customer that is leasing or owns the holographic poster 101. In this case, once the mobile app 427 is installed, it does not need to be reinstalled again for the next holographic poster 101. In another embodiment a different mobile app 427 might be required for specific holographic poster 101.

The mobile app 427, when running on the mobile device 425, is used to determine the proximity of a user to a holographic poster 101 and can also be used to map out the positions of nearby holographic poster 101. Having this information will allow the app to guide the user to the nearest holographic poster 101. The app 427 or device 425 can “sense” proximal ones of holographic poster 101 and measure the distance to them. Distance to a poster 101 may be measured by any suitable mechanism.

In some embodiments, distance between a device 425 and a poster 101 is measured using GPS. For example, when the holographic poster 101 is outdoors, the proximity of the mobile device 425 to a holographic poster 101 can be determined using the Global Positioning System (GPS).

FIG. 7 illustrates proximity determination via GPS radius. The method uses the GPS position of a poster 101 and defines a circular area with a given radius surrounding that poster 101, and can also do the same for a mobile device 425. That circular area surrounding the device is used to map the communication area for that poster 101 or device 425. This area is defined for both mobile devices 425 and for holographic poster 101. If the area of a mobile device 425 overlaps with the area of a holographic poster 101 then the two are said to be close enough to begin communication. The radius of the area can be uniform for all devices or alternatively it can be different for each device and can be determined by the type and capabilities of a mobile device (for example it's transmission strength). The radius for a holographic poster 101 might also be determined by its surroundings; for example if a holographic poster 101 is in the open then the radius could be larger whereas a holographic poster 101 in a crowded space would have a smaller radius forcing users to get closer before initiating communications.

In some embodiments, distance determination involves Wi-Fi trilateration. For example, the GPS positioning method may not be suitable when a holographic poster 101 is indoors due to signal attenuation from building material and reflections that cause multipath errors. Instead there is provided herein an indoor method for determining the proximity of a mobile device to a holographic poster 101.

FIG. 8 shows trilateration using stationary routers. The method uses Wi-Fi technology to determine the position of a mobile device relative to the positions of several stationary Wi-Fi routers. This is done by pinging at least three Wi-Fi routers to trilaterate the position of a device. Both the position of mobile devices 425 and the position of holographic posters 101 can be determined in this way. As long as the relative positions of the Wi-Fi routers are known, then the positions of the mobile 425 and holographic poster 101 can be determined. To simplify the process the routers can be placed at the holographic poster 101 thereby eliminating the need to calculate the positions of the holographic poster 101.

FIG. 9 shows an alternative method using a direct Wi-Fi connection and proximity detecting using SSID broadcasting. In this embodiment, the registration process between a mobile device and a holographic poster 101 is determined by the strength of the broadcast SSID signal strength from the holographic poster 101 or from a Wi-Fi router placed at the holographic poster 101. In this embodiment the signal strength is used as a proxy for the distance between the mobile device and the holographic poster 101. When the signal strength passes a threshold the devices would be considered close enough to initiate the registration procedure. The SSID signal is used in conjunction with the SSID proprietary name within the app to parse the available SSIDs to extract and match a unique string pattern that was pre-configured to match with a specific holo device.

The invention provides systems and methods that include augmented reality functionality to accomplish tasks described herein more effectively than prior art communication. Augmented reality (AR) includes systems and methods that include a live, direct or indirect, view of a physical, real-world environment whose elements are augmented by computer-generated sensory input such as sound, light projection, facial recognition, mimicry, video, graphics or GPS data. Exemplary systems and methods including augmented reality that may be modified for use with the invention are described in U.S. Pat. No. 8,840,548; U.S. Pat. No. 8,275,414; U.S. Pub. 2013/0124326; U.S. Pub. 2013/0010068; U.S. Pub. 2012/0242865; U.S. Pub. 2012/0167135; and U.S. Pub. 2009/0061901, the contents of each of which are incorporated by reference. Examples of AR functions include using a smartphone as a world-viewer that reproduces the view that would be seen through the phone onto the screen of the phone and adds informational elements from a computer system. Another example of an AR functionality includes facial recognition by a camera and processor through a poster 101 and providing a holographic display that address a user with personalized information (e.g., a 3D image of a sword-fighter appears and speakers play, “Hi John, use your smartphone as a sword and best me in fencing to receive a free soda before going into the theater to watch Swordmasters!” In certain embodiments, holographic poster 101 will use an augmented reality mechanism within an application on the mobile device. Augmented reality allows a phone to display digital information superimposed on top of the phone's live video feed where the displayed information is related to the content in the video. The app would allow a user to point their mobile device anywhere in their immediate surroundings and visually identify the available holographic poster 101 on their screen.

FIG. 10 illustrates augmented reality showing the location of holographic poster 101 for a sports team and one for a soft drink brand. As illustrated, a user might see some form of branded icons or thumbnails indicating the position of holographic poster 101 in the vicinity. If the user chooses to select a specific holographic poster 101 then they might see the current content being displayed on the said holographic poster 101. The user could then zoom into the holographic poster 101 and see if this content is of interest to them. Selecting the icon of a holographic poster 101 would lead to a map with instructions on how to reach this specific holographic poster 101. The directions could appear in a standard 2D map view or they may appear within the augmented reality display with the directions appearing within the live video as the user points the phone in different directions.

FIG. 11 depicts use of augmented reality with directions to a holographic poster 101 at street level. As illustrated in FIG. 11, a user is using a device 425 and app 427 for AR functionality to go to the physical location of a poster 101 (e.g., to watch a highlights clip from an in-progress sports game, to participate in a contest for free tickets, to check a social network page to see what friends will be attending an upcoming sports game, etc.)

The search for a holographic poster 101 via a custom augmented reality procedure may involve an augmented reality module within the application. This module is responsible for querying a server database that contains the location data for all the holographic poster 101. This location data could be a latitude/longitude GPS coordinate or a series of custom SSID-identified labels from which basic location information can be extracted (usually mapping to static latitude/longitude coordinates). Once the server is queried for this location information, the server may send back a series of available holographic poster 101 nearby.

In addition to location information, the servers 409 may also be queried for brand information since a holographic poster 101 may be owned by a brand at a certain point in time for a specific duration and then switch to another brand at another time. The augmented reality module will display the brand information on the virtual three-dimensional map representation. Both the location and the compass information on the phone are used to determine a line of sight and to display all available holographic posters 101 in a certain direction. Note that only the basic location information need be sent to the server which may then returns a set of holographic poster 101 coordinates around the radius from this location. Augmented reality may have further applications in promotion and purchasing.

FIG. 12 gives an augmented reality view with preview of holographic content from selected device 101. Here, a user has “looked at” the crowd through device 425 and spotted locations of a poster 101 with communications about a sports team and another poster 101 with communications about a beverage. The user has used a touch screen to select the poster 101 that relates to the beverage brand, and device 425 has initiated a program showing a beverage that may be available. The program may go on to illustrate consumption of the beverage, or to report to the user such information as price or a length of a line of people waiting to purchase the beverage. The search for a holographic poster is dynamic and one specific holographic poster 101 at a specific location might not always be representing the same brand depending on the time of the day or period of the year. Multiple brands may lease one specific holographic poster 101.

Both indoor and outdoor mechanisms are complementary and can be used to find and identify the nearest holographic poster 101 as well as provide a mechanism to map their positions. A handoff procedure would be used to switch from an outdoor mechanism to an indoor mechanism. In one embodiment while a user is outdoors and using a GPS positioning method, the position of any indoor holographic poster 101 may not be accurately known. This is because the user would generally be too far to connect to the indoor Wi-Fi network to receive accurate positioning information. Because of this, the mobile device might only be in possession of the number of holographic poster 101 within a certain building and not their specific locations. Accordingly the display on the mobile device (while it is outdoors) could show all indoor holographic poster 101 with a group symbol that denotes to the user that the devices are indoors and their positions are not accurately known. However, the number of indoor devices could be shown on the group symbol. Once the user comes close enough to connect to the Wi-Fi network directly then the information about the position of the indoor holographic poster 101 would be shown.

The invention provides systems and methods for registration (step 633 in FIG. 6). Once a user has found and approached a holographic poster 101, and it is determined that they are close enough then registration can be initiated. Registration may be accomplished by communication with the servers 409 which act as intermediaries between the mobile device 425 and the holographic poster 101. The servers 409 may act to synchronize the communications between the two devices and allows the input on the mobile device 425 to be synched to the display on the holographic poster 101 in real time. The servers 409 may also keep records of user registration to determine if registration is necessary when a mobile device 425 approaches a holographic poster 101.

In some embodiments, the servers 409 reside in an online cloud environment. Preferably, network 421 includes the internet. The communication channel in network 421 between a device 425 or poster 101 may be established in any suitable way known in the art. For example, the mobile device 425 can have two-way communication (optionally mediated by a front-end server) via a local Wi-Fi network which connects to the servers 409 on the internet. Additionally or alternatively, the mobile device 425 can have two-way communication (optionally mediated by a front-end server) via a wireless telephone network (such as 4G/LTE/GSM) which connects to the servers 409 on the internet.

Further, holographic poster 101 can have two-way communication via a wireless telephone network (such as 4G/LTE/GSM) which connects to the servers 409 on the internet. Additionally or alternatively, the holographic poster 101 can have two-way communication with servers 409 via a local Wi-Fi network which connects to the servers 409 on the internet. Holographic poster 101 can have two-way communication with servers 409 via a local area network. The holographic poster 101 would be connected to the local area network with a physical network cable. The local area network would connect to the servers 409 on the internet

FIG. 13 diagrams communication layers between a mobile device and a holographic poster 101 In another embodiment the servers would not be online, but rather they would be placed locally with the holographic poster 101. In such cases the internet would not be required.

In some embodiments, communication between a device 425 and a poster 101 includes a direct component. For example, a mobile device 425 may communicate directly with the holographic poster 101 via a Bluetooth connection. The mobile device could communicate directly with the holographic poster 101 via a local Wi-Fi network.

FIG. 14 illustrates direct Bluetooth connection between a mobile device 425 and a holographic poster 101. Registration is initiated when the mobile app 427 on the mobile device 425 fetches the holographic poster 101 ID and performs a check to determine if the user has already been registered for this specific holographic poster 101 or for a specific group of devices. Registration of the mobile user's ID can involve social media authentication mechanisms such as Facebook, Google+, Twitter, OAuth or OpenID.

If a mobile device is registered with one holographic poster 101 in a group then it may be registered with all the devices in the group such that there is no need to reregister if the mobile device 425 moves to another holographic poster 101 in the group. As an example, consider that dozens of holographic poster 101 are in a stadium and belong to the same group, then a mobile device registered to one would be registered to all of them. However, if there are dozens of devices 101 in a stadium but 50 are owned by a soft drink company and 50 are owned by an auto company, then the user may be required to register two times [or would be auto registered a second time using info provided by the user during the first registration]. In a second embodiment of the present concept, the user could register once only for all groups but the data would be sent each time a new group (or brand) is encountered.

Once a mobile device 425 has approached and registered with a holographic poster 101 it is locked-in to this holographic poster 101. When the mobile device is locked-in, it is ready for queuing. The user can be asked if they want to interact with the holographic poster 101 and then inserted into a queue of available interaction slots, which illustrates one method for managing multiple participants.

After a mobile device 425 locks in to a holographic poster 101, the mobile app 427 can be dynamically re-skinned with branding from the holographic poster 101. For example a generic welcome screen of app 427 may be re-skinned based on the brand of the locked-in holographic poster 101. This mechanism allows many brands (for example in a stadium) to sponsor, own, or lease holographic poster 101 and provide brand-specific visuals or themes to be used by the mobile app 427.

FIG. 15 shows registration and queuing (step 649 in FIG. 6) with multiples of mobile device 425 according to systems and methods of the invention. In some embodiments, once the user is locked into a holographic poster 101 they may enter a queue on the said holographic poster 101 for a chance to interact directly with the holographic poster 101. The holographic poster 101 itself may display the names of the users in the queue or the mobile app 427 may display. There can also be a call to action for the user to interact with the device.

While a holographic poster 101 may allow only one user at a time, alternatively, a holographic poster 101 may accept multiple simultaneous users if they are queued as a group. This might occur if the holographic poster 101 is used to display content related to a game where two users would compete against each other. A user may skip registration and go directly to queuing if the user is already registered but the user will always be queued before interacting with the holographic poster 101. Once the user is called to interact with the holographic poster 101, the mobile app 427 transforms itself into a controller to interact with the content being projected on the holographic poster 101.

FIGS. 16A and 16B illustrate use of a mobile device 425 to control holographic poster 101. Sensor information from the mobile device 425 may be used to control the hologram projected on the holographic poster 101. This sensor information would include information from the gyroscope, accelerometers, microphone, GPS/locationing functionality, or other mechanisms of device 425, particularly mechanisms related to the phone movement and orientation such as tilt and rotation. Also the sensor information may include gesture information such as display swipes (e.g., where the finger of a user swipes across the screen) and any other mobile phone interactions. This sensor information is transmitted to server 409 and is used to reconfigure the content being broadcasted to the holographic poster 101.

The reconfiguring can include the following functions such as geometry transformations, motion control, selection, view control, other content manipulation, and combinations thereof. For example, the transformation of the content geometry may include resizing, deformation and cropping of the content. This can be done with input from the touch screen of the phone. For example, the user can perform a pinch movement with two fingers to squeeze the displayed hologram.

The reconfiguring can also include the control over the movement of the hologram or one part of the hologram. For example the movement of the user's finger on the touch screen of the phone can be directly linked to the movement of the hologram or a part thereof.

The selection of other content much as a lateral swipe on a touch screen phone allows a user to browse through a series of images. In this case the holographic image on the display device would cycle through a series of holograms.

The reconfiguring can also include the selection of options such as engaging drop-down menus. These menus might appear only on the phone or can also appear on the holographic display.

And the reconfiguration can also include the transformation of 3D cameras. In this situation the user would be able to change the 3D viewing angle of the hologram.

This is how the user may, through a mobile device 425 and mobile app 427 interact with the holographic content being displayed without the usage of complex sensors on the holographic poster 101 itself.

Controlling a holographic poster 101 through a mobile device rather than with complex sensors can have the numerous benefits. For example, using sensors of a mobile device 425 pushes interaction and control to a user giving greater incentives for a user to actually register (e.g., through a social media website identity pass-through), which may encourage and aid the collection of crucial marketing data. Additionally, the increases the interactive functionality of a holographic poster 101 without requiring complex and expensive sensing equipment to be installed on the poster. Further, using sensors out on device 425 aid in sifting through a crowd and sourcing motion, control, selection, and other inputs to individual members of a crowd.

In some circumstances a plurality of users will be able to interact with and control the holographic poster 101 or a part of it. For example there could be two users playing a game, or otherwise competing with each other, where each user controls one part of the hologram.

FIG. 17 shows an example of two users playing an interactive game of holographic chess. Each user is controlling only part of the hologram (their own pieces). Some games may involve simultaneous control from each user while other situations (such as chess) could employ a cyclic handoff strategy. A cyclic handoff would allow two locked-in users to alternate control of the holographic poster 101 so that each user gets a turn at controlling the device and responding to what the other user has done all while keeping other users locked-out.

The invention includes systems and methods for terminating a user's interaction with a holographic poster 101. The interaction of the user with the holographic poster 101 can be terminated any suitable way including, for example, a user traveling away, a paramount user logging in/registering, a system termination (e.g., for service updates), a termination relevant to content context (end of a movie clip, game, etc., or beginning of a real-world event such as sports event), or others. For example, a user can walk away from the holographic poster 101. The connection between the mobile device and the holographic poster 101 may be severed if the mobile device moves outside of the range that initiated the registration. Alternatively, a user specifically selects an END option on mobile app 427.

FIG. 18 gives a diagram of termination according to some embodiments. In some embodiments, a user is timed out either due to a time limit or if the user has not interacted with the mobile device for a specific number of seconds. Any such situation may trigger a termination procedure and send data to servers 409. One option would see a terminated user remain registered and simply go to the back of the queue to wait for another turn at interacting with the holographic poster 101. This option would only occur if the user remained in a registered state (i.e. stayed within range of the holographic poster 101).

What is claimed is:

1. A holographic display device comprising a memory coupled to a processor and operable to:
receive from a mobile device information identifying a user of the mobile device,
register a user of the mobile device as a present user of the holographic device,
receive an input from the registered user, and
present a holographic display that includes content governed by the input.

2. The display device of claim 1, further comprising a camera, and further operable to user the processor to perform a facial recognition process to receive the information identifying the user.

3. The display device of claim 2, wherein the holographic display comprises an image of a face and an animated interaction of the image of the face with the user.

4. The display device of claim 2, further operable to use the processer to determine the identity of the user and then to select a likely content preference of the user based on the facial recognition operation.

5. The display device of claim 1, further operable to user the processor to receive a registration request transmitted by a mobile app on the mobile device.

6. The display device of claim 1, further operable to user the processor to detect a presence of the mobile device and associate the mobile device with an account for the user.

7. The display device of claim 1, further operable to user the processor to register a plurality of users of mobile devices and queue users to receive a plurality of different holographic displays.

8. The display device of claim 1, further operable to associate the user with a unique account, retrieve a content category identifier from the account, and receive the content from a server system based on the content category identifier.

9. The display device of claim 1, wherein the device is operable to select the content based on an identity of the user.

10. The display device of claim 9, wherein the content comprises an interactive display.

11. The display device of claim 10, wherein the interactive display comprises holographic images of characters and further wherein the device is operable to receive controlling input originating from the user's use of the mobile device and control the holographic images of the characters according to the controlling input.

12. The display device of claim 1, further operable to user the input to select the content.

13. The display device of claim 1, further operable to prompt the user to install a mobile app onto the mobile device.

14. The display device of claim 13, wherein prompting the user includes a visual sign or code.

15. The display device of claim 1, wherein the processor is operable to generate a live view of a real-world environment that includes artificial computer-generated elements.

16. The display device of claim 1, further operable to determine the proximity of the mobile device to the display device.

17. The display device of claim 1, further operable to present the holographic display at least a few feet above ground and including images at least about a foot wide and a foot tall.

18. The display device of claim 1, further operable to use the processor to execute a handoff procedure between a first communication modality with the mobile device and a second communication modality, and further wherein communication with the mobile device is uninterrupted throughout a duration of the handoff procedure.

19. The display device of claim 18, wherein the first communication modality comprises Wi-Fi and the second communication modality comprises cellular telephony data systems.

20. The display device of claim 1, further operable to detect an approach of the mobile device and register the user in response to the detected approach.

21. The display device of claim 1, further operable to register the user by communicating with a server system.

22. The display device of claim 1, further operable to use a server system to synchronize the holographic display to actions on the mobile device.

23. The display device of claim 1, further comprising a data communication device for connecting to the Internet.

24. The display device of claim 1, further operable to register the user by retrieving information from a social media web site.

25. The display device of claim 1, further comprising a data connection to a server system operable to control a group of holographic poster devices to provide a concerted information campaign.

26. The display device of claim 25, further operable to relay a user registration to an entirety of the group of holographic poster devices.

27. The display device of claim 1, further operable to lock the mobile device, recognize the presence of a plurality of additional devices, and maintain the locked-in mobile device as the sole locked-in device.

28. The display device of claim 27, further operable to prompt the user through the mobile device to ask if they want to interact with the display device.

29. The display device of claim 1, further operable to insert the user into a queue of available interaction slots.

30. The display device of claim 1, further operable to re-skin a mobile app on the mobile device with a new skin, the skin comprising at least one element in common with the holographic display.

31. The display device of claim 30, wherein the at least one element comprises a trademark.

32. The display device of claim 1, further operable to register and queue multiple additional mobile devices.

33. The display device of claim 1, further operable to display names from an interaction queue.

34. The display device of claim 1, further operable to accept multiple simultaneous users queued as a group.

35. The display device of claim 1, further operable to display content related to a game

36. The display device of claim 1, further operable to go directly to queuing if the user is already registered.

37. The display device of claim 1, further operable to use the processor to reconfigure content of the holographic display based in additional input from the mobile device.

38. The display device of claim 37, wherein the reconfiguring includes geometry transformations, motion control, selection, view control, other content manipulation, and combinations thereof.

39. The display device of claim 1, further operable to move the contents of the holographic display in accordance with movement of the user's finger on a touch screen of the mobile device.

40. The display device of claim 1, further operable to cycle through a series of holograms in response to a swiping input.

41. The display device of claim 1, further operable to use a 3D camera to capture a 3D image, receiving pan-and-scan input from the user, move the 3D camera, and adjust the 3D image.

42. The display device of claim 1, further operable to use sensors on the mobile device to aid in sifting through a crowd and source an action of the user to that user despite the presence of the crowd.

43. The display device of claim 42, further operable to use a sensing mechanism on the display device to receive additional input containing information about the action sourced to the user.

44. The display device of claim 1, further operable to allow two locked-in users to alternate control of the display device.

45. The device of claim 1, further operable to terminate the user's control of the display device.

46. A mobile device for controlling a holographic display, the device comprising:
a mobile form-factor body;
a processor coupled to a memory and housed by the body;
at least one input-output mechanism for receiving an input from a user;
at least one communication mechanism for sharing information with a holographic poster; and
instructions stored in the memory executable by the processor to cause the device to transmit the input to the holographic poster and influence a holographic display presented by the poster.

47. The mobile device of claim 46, further operable to determine positions of nearby holographic posters

48. The mobile device of claim 46, further operable to sense a proximal holographic display device.

49. The mobile device of claim 46, further operable to determine a distance to a holographic display device.

50. The mobile device of claim 49, wherein the distance determination makes use of one selected from the list consisting of GPS, Wi-Fi trilateration, and SSID broadcasting.

51. The mobile device of claim 46, further operable to be used as a controller to interact with content being displayed on a holographic display device.

52. The mobile device of claim 46, further comprising at least one positional sensor.

53. The mobile device of claim 52, wherein the positional sensor comprises a gyroscope, accelerometers, or GPS structure.

54. The mobile device of claim 46, further comprising a touch screen operable to receive and digitize gesture information.

55. The mobile device of claim 46, further operable to receive a user selection of a specific holographic poster and display a version of a portion of current content being displayed on the specific holographic poster.

56. The mobile device of claim 55, further operable to display a map with instructions on how to reach the specific holographic poster.

57. The mobile device of claim 46, further operable to display an augmented reality display with annotation information appearing within a live video as the user points the phone in different directions.

58. The mobile device of claim 46, further operable query a server database that contains the location data for all holographic display devices within a defined group.

59. The mobile device of claim 46, further operable to send information identifying a present location of the mobile device to a server and receive a set of coordinates for holographic display devices within a pre-determined radius from the present location.

60. The mobile device of claim 46, further comprising camera and a screen and wherein the device is operable show a display with contents that mimic a view behind the screen of the device and to include additional information in the contents.
